(19) United States
(12) Patent Application Publication
(10) Pub. No.: US 2004/0125509 A1
(43) Pub. Date: Jul. 1, 2004

(54) Method for fabricating multilayered thin film PZT structures for small form factors

(75) Inventors: Xiao Yang, Fremont, CA (US); Visit Thaveeprungsriporn, Bangkok (TH); Szu-Han Hu, Bangkok (TH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: KR Precision Public Company Limited, Ayutthaya (TH)

(21) Appl. No.: 10/331,196

(22) Filed: Dec. 27, 2002

(51) Int. Cl. G11B 5/56

(52) U.S. Cl. 360/294.3

(57) ABSTRACT

An integrated gimbal and PZT structure. The structure includes a substrate, which has a first surface and a second surface. The first surface is opposite to the second surface and sandwiches a thickness of material of the substrate. The structure also includes an isolation layer formed overlying the first surface of the substrate and a patterned layer of PZT material overlying the isolation layer overlying the substrate. A tongue portion is formed from a first portion of the substrate for a gimbal structure of a suspension assembly. A spring portion is formed from a second portion of the substrate. The spring portion is coupled between a lower portion of the suspension assembly and the tongue portion.

### BACKGROUND OF THE INVENTION

This invention generally relates to techniques for operating a disk drive apparatus. More particularly, the present invention provides a method and apparatus for reading and writing information onto a computer disk commonly called a hard disk for memory applications. Merely by way of example, the present invention is implemented using such method and apparatus with an actuating device coupled between a read/write head and support member for fine tuning the read/write head onto a data track on the hard disk, but it would be recognized that the invention has a much broader range of applicability.

Storage of information has progressed through the years. From the early days, primitive man stored information on walls of caves, as well as used writings on wood such as bamboo. Since then, people have used wood, silk, and papers as a media for writings. Paper has been bound to form books. Information is now stored electronically on disks, tape, and semiconductor devices. As merely an example, some of the early disks used magnetic technology to store bits of information in a digital manner onto the magnetic media. One of the first disk drives was discovered in the 1950's by International Business Machines of Armonk, N.Y. Although such disks have been successful, there continues to be a need for an improved storage device.

From the above, it is seen that an improved way to operate a disk drive is highly desirable.

### SUMMARY OF THE INVENTION

According to the present invention, techniques for operating a disk drive apparatus are provided. More particularly, the present invention provides a method and apparatus for reading and writing information onto a computer disk commonly called a hard disk for memory applications. Merely by way of example, the present invention is implemented using such method and apparatus using with an actuating device coupled between a read/write head and support member for fine tuning the read/write head onto a data track on the hard disk, but it would be recognized that the invention has a much broader range of applicability.

In a specific embodiment, the invention includes a method for fabricating an integrated suspension structure and PZT structure. The method includes forming an isolation layer overlying a first surface of a substrate and forming a layer of PZT material overlying the isolation layer, the substrate being a portion of an actuator device. The method then patterns the layer of PZT material.

In an alternative specific embodiment, the the invention includes an integrated gimbal and PZT structure. The structure includes a substrate, which has a first surface and a second surface. The first surface is opposite to the second surface and sandwiches a thickness of material of the substrate. The structure also includes an isolation layer formed overlying the first surface of the substrate and a patterned layer of PZT material overlying the isolation layer overlying the substrate. A tongue portion is formed from a first portion of the substrate for a gimbal structure of a suspension assembly. A spring portion is formed from a second portion of the substrate. The spring portion is coupled between a lower portion of the suspension assembly and the tongue portion.

In an alternative specific embodiment, the invention a method for fabricating an integrated gimbal and PZT structure. The method includes forming a first isolation layer overlying a first surface of a substrate. The substrate is a portion of a gimbal structure. The method also forms a second isolation layer overlying a second surface of the substrate and forms a first electrode layer overlying the first isolation layer. The method forms a layer of PZT material overlying the first isolation layer using a deposition process maintained at less than 300 Degrees Celsius. The method forms a second electrode layer overlying the PZT material and patterns the layer of PZT material, the first electrode, and the second electrode. The method also patterns the substrate to define the portion of the gimbal structure.

Numerous benefits are achieved using the present invention over conventional techniques. For example, the present invention can be implemented using conventional technologies. Additionally, the present invention can provide for alignment of a read/write head assembly to disk densities of 100 Gigabit per square inch of material and greater. In certain embodiments, the present invention can be implemented using a small form factor, e.g., less than 100 microns in thickness, which results in a less error from “windage.” The invention can also be easy to manufacture and apply according to certain embodiments. As merely an example, the conventional PZT film is often 200 microns and are often stacked to form thicker multilayer structures. Such multilayered structures are often required to cause a certain level of actuation force and displacement. Unfortunately, the stacks become too thick for conventional applications. Here, the total thickness becomes too large for smaller applications. The present invention overcomes certain limitations of the conventional PZT film. Depending upon the embodiment, one or more of these benefits may be used. These and other benefits are described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified top-view diagram of an apparatus according to an embodiment of the present invention;

FIG. 2 is a side view diagram of a movable arm according to an embodiment of the present invention; and

FIGS. 3 through 6 are simplified diagrams illustrating a method according to an embodiment of the present invention.

### DESCRIPTION OF THE SPECIFIC EMBODIMENTS

According to the present invention, techniques for operating a disk drive apparatus are provided. More particularly, the present invention provides a method and apparatus for reading and writing information onto a computer disk commonly called a hard disk for memory applications. Merely by way of example, the present invention is implemented using such method and apparatus using with an actuating device coupled between a read/write head and support member for fine tuning the read/write head onto a data track on the hard disk, but it would be recognized that the invention has a much broader range of applicability.

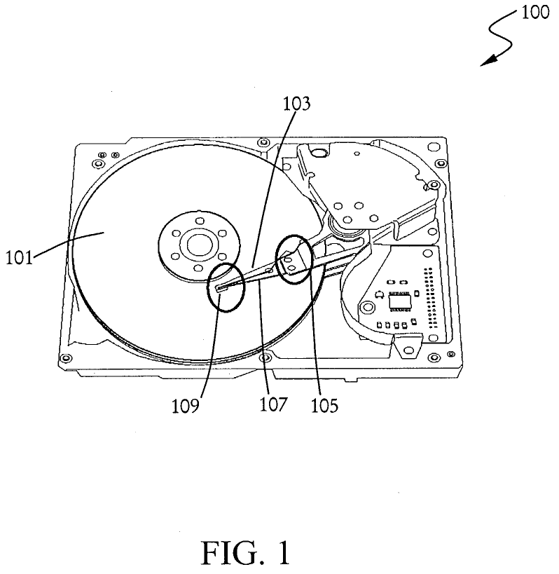

FIG. 1 is a simplified top-view diagram 100 of a disk drive apparatus according to an embodiment of the present invention. This diagram is merely an example, which should not unduly limit the scope of the claims herein. One of ordinary skill in the art would recognize many other variations, modifications, and alternatives. As shown, the apparatus 100 includes various features such as disk 101, which rotates about a fixed axis. The disk also includes tracks, which are used to store information thereon. The disk rotates at 7,200 RPM to greater than about 10,000 depending upon the embodiment. The disk, commonly called a platter, often includes a magnetic media such as a ferromagnetic material, but can also include optical materials, common coated on surfaces of the disk, which become active regions. Overlying the disk is head assembly 103, which operates and controls a slider 109 coupled to a read/write head. The head assembly is coupled to a voice coil motor, which moves the head assembly about a pivot point in an annular manner. The voice motor coil moves using a frequency of up to about 1 kHz. Preferably, the speed is at least 5 kHz, but can also be greater in certain embodiments. Further details of the head assembly are provided throughout the present specification and more particularly below.

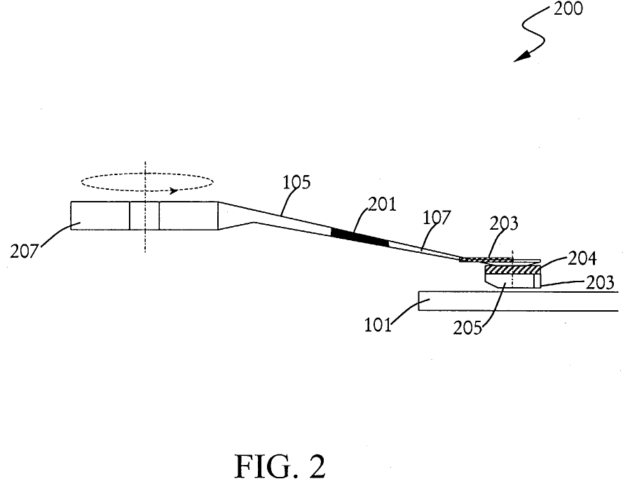

FIG. 2 is a side view diagram of a movable arm 200 according to an embodiment of the present invention. This diagram is merely an example, which should not unduly limit the scope of the claims herein. One of ordinary skill in the art would recognize many other variations, modifications, and alternatives. Like reference numerals are used in this diagram as certain other diagrams herein, which should not be limiting. As shown, the assembly includes suspension 105 coupled to voice coil motor 103. Slider 207 is coupled to another end of the suspension. The slider includes read/write head 205. The head is positioned over a track 101, which is among a plurality of tracks on the disk.

Preferably, the arm assembly also includes actuator device 203 coupled between the slider 207 and tongue and gimbal structure 209. The actuating device moves the head in a direction normal to a direction of the track according to a specific embodiment. Preferably, the actuating device is made of a PZT material, which is operable in the transverse mode, but can also be in other modes. The actuating devices moves the slider including head within a distance of about two microns and less and preferably one micron and less. The slider and head also move at a frequency of about 5 kHz and more, depending upon the embodiment. Of course, one of ordinary skill in the art would recognize many alternatives, variations, and benefits.

In a specific embodiment, the present invention provides a method for fabricating an integrated head structure and multilayered PZT structure. Preferably, the method can be outlined as follows:

1. Provide a substrate, e.g., stainless steel.

2. Form a layer of polyimide underlying a bottom surface of the substrate;

3. Form a conductive layer (e.g., metal, copper, platinum) overlying the polyimide layer to form an electrode layer;

4. Form a PZT film overlying the electrode layer;

5. Form a layer of polyimide overlying an upper surface of the substrate;

6. Form a metal layer overlying the polyimide layer overlying the upper surface;

7. Pattern the metal layer overlying the polyimide layer overlying the upper surface;

8. Form photoresist layer overlying patterned metal layer to product the patterned metal layer;

9. Form photoresist layer overlying the PZT layer;

10. Pattern the PZT layer;

11. Strip photoresist layers;

12. Form photoresist layer overlying patterned PZT layer to product the patterned PZT layer;

13. Form photoresist layer overlying substrate;

14. Pattern the substrate to form gimbal structure and release the substrate from the patterned conductive layer;

15. Strip photoresist material; and

16. Perform other steps, as desired.

Further details of the method are provided using the diagrams outlined below.

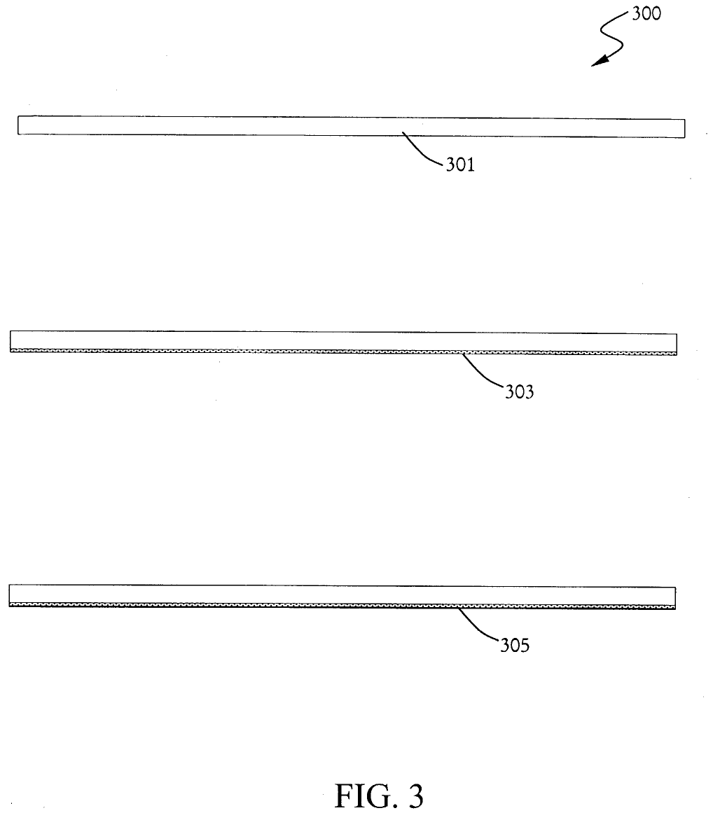

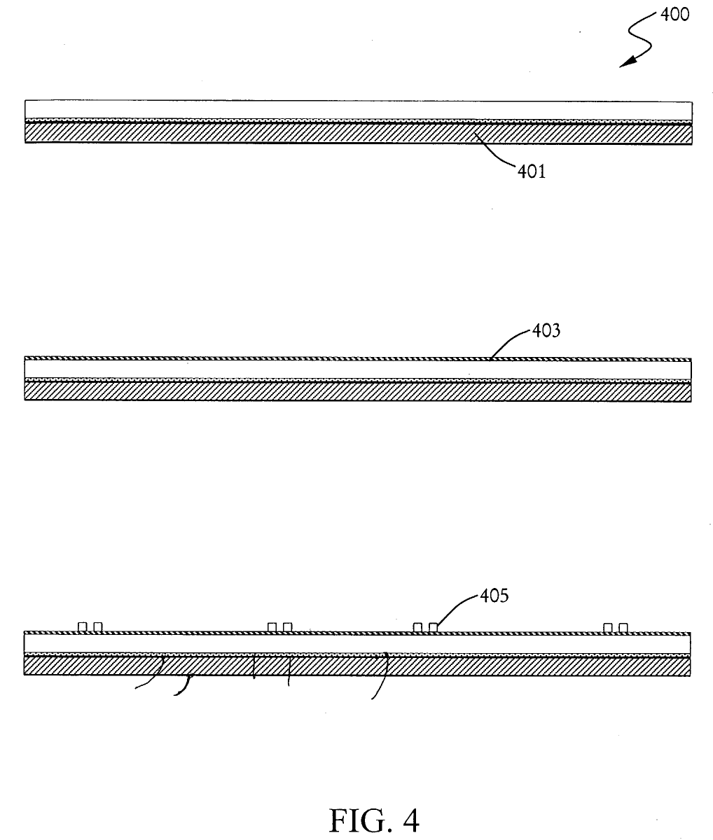

FIGS. 3 through 6 are simplified diagrams illustrating a method 300 according to an embodiment of the present invention. These diagrams are merely examples, which should not unduly limit the scope of the claims herein. One of ordinary skill in the art would recognize many other variations, modifications, and alternatives. As shown, the method includes providing a substrate 301, e.g., stainless steel. The substrate can be made of a suitable layer, which has flexibility and enough strength, including stiffness.

As shown, the method forms a layer of polyimide 303 underlying a bottom surface of the substrate. Alternatively, another layer of insulating material can be used depending upon the application. Preferably, the polyimide is spin coated using conventional techniques. The polyimide is often coated to a thickness of about 10 microns or less in a specific embodiment. The method forms a conductive layer 305 (e.g., metal, copper, platinum) overlying the polyimide layer to form an electrode layer. The conductive layer is often deposited using a deposition process such as sputtering or the like. The conductive layer is often thin and ranges in thickness from about 200 nanometers and thinner, depending upon the embodiment.

The method also forms 401 a PZT layer overlying the conductive layer. The PZT layer can be a piezoelectric material such as piezoelectric ceramics (e.g., barium titanate, lead zirconate tinanate (PZT)), piezo crystal (e.g., quartz), piezo polymer (e.g., polyvinylidene difluoride (PVDF)), among others. Preferably, the PZT layer is formed at a temperature less than 300° C.

The method forms a layer of polyimide 403 overlying an upper surface of the substrate. The method then forms a metal layer overlying the polyimide layer overlying the upper surface. The metal layer can be any suitable material such as copper, platinum, etc. The metal layer 405 is patterned using a masking and etching step or other suitable techniques overlying the polyimide layer overlying the upper surface. The patterned metal layer becomes conduction layers, which will be used for the present apparatus.

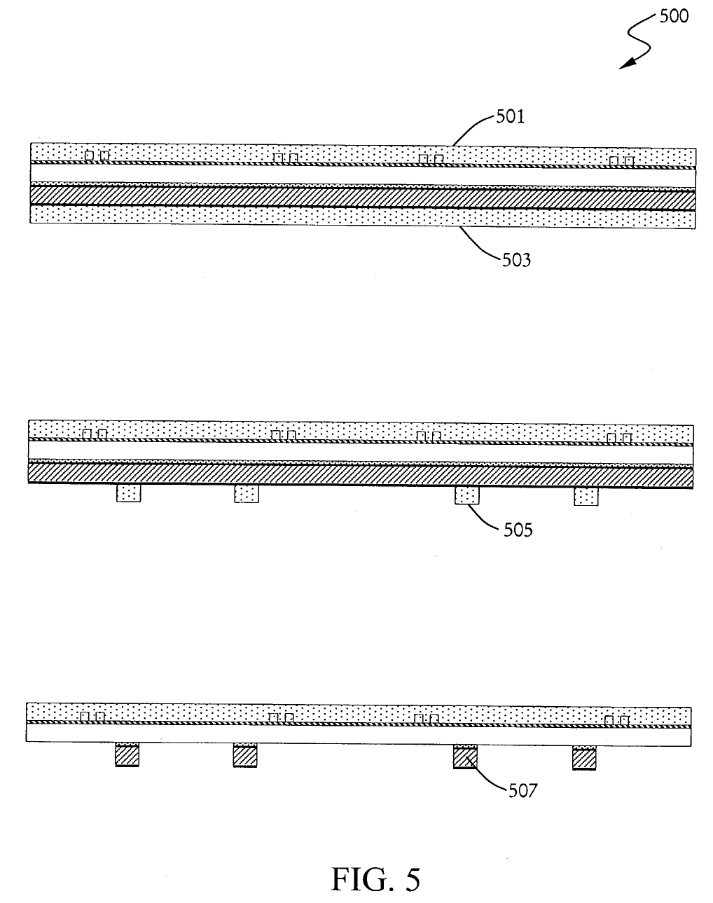

Referring to FIG. 5, the method 500 then forms photoresist layer 501 overlying patterned metal layer to product the patterned metal layer. The method also forms photoresist layer 503 overlying the PZT layer. Preferably, the coating process can be performed in a single step, although multiple steps can be used in other embodiments. The method patterns the lower photoresist material to pattern the PZT layer 505, which is shown. The patterned PZT layer can be used for various structures such as those previously described among others. The PZT layer is patterned 507 and the photoresist layer overlying the PZT layer is stripped.

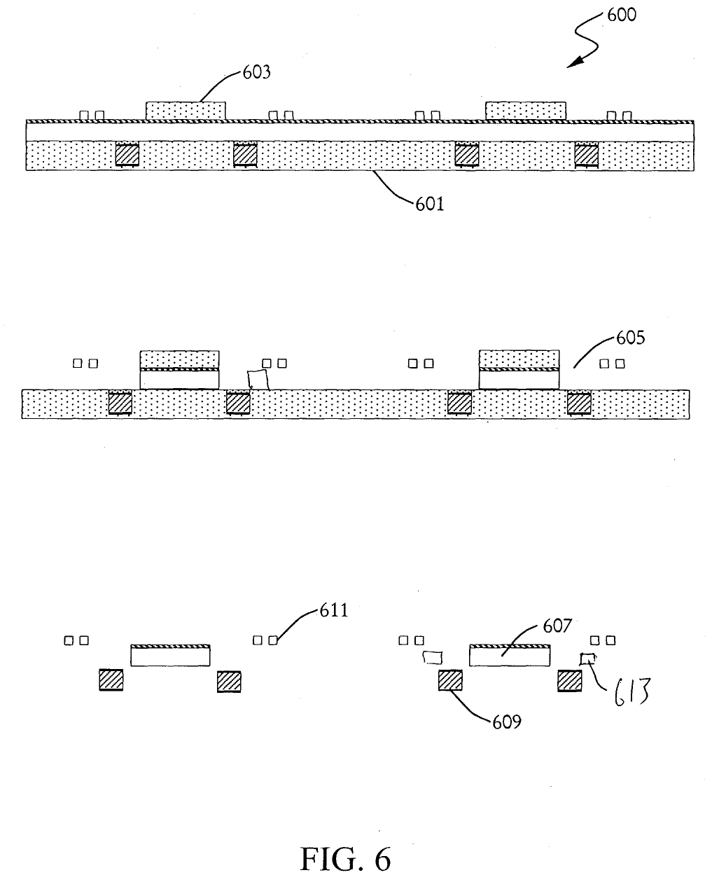

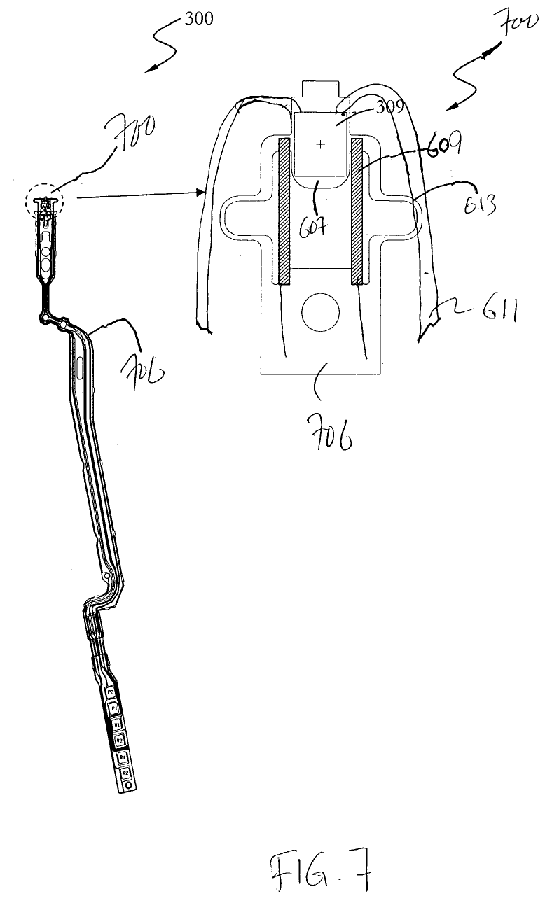

Referring to FIG. 6, the upper photoresist film is patterned 603 (refer also to reference numeral 600). The method also forms photoresist layer overlying patterned PZT layer to product the patterned PZT layer. The method patterns 605 the substrate material to form gimbal structure and release the substrate from the patterned conductive layer, as shown. Depending upon the embodiment, the method strips the photoresist layer to free the conductive structures 611, PZT layer 609, and substrate structure, which forms gimbal 605. Depending upon the embodiment, there can be many modifications, variations, and alternatives.

Referring to FIG. 7, a simplified top-view diagram of a resulting apparatus 700 is illustrated. Like reference numerals are used in this diagram as others, which would not be limiting the scope of the claims herein. As shown, the diagram of the apparatus 700 includes PZT actuation structures 609, gimbal structure 607, such as tongue, which is coupled to a lower portion of the gimbal through spring structure 613. The spring structure may be a folded structure, such as the one shown, as well as others. The apparatus also includes conductive layer or layers 611, which couple to the read/write head. The read/write head, which is on slider, couples to lower read/write assembly process. Preferably, there are a pair of PZT structures 609. Each PZT structure includes a first end and a second end provided along an elongated portion. The first end is coupled to a tongue portion of the gimbal structure and the second end is coupled to a lower end of the gimbal structure. Each of the PZT structures can operably move to allow the tongue portion, including slider, to rotate about a center region. Further details of the apparatus are provided in U.S. Ser. No. ______ (Attorney 021612-000700US), which is commonly owned, and hereby incorporated by reference for all purposes.

One of ordinary skill in the art would recognize many other variations, modifications, and alternatives. The above example is merely an illustration, which should not unduly limit the scope of the claims herein. One of ordinary skill in the art would recognize many other variations, modifications, and alternatives. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for fabricating an integrated suspension structure and PZT structure, the method comprising:
forming an isolation layer overlying a first surface of a substrate, the substrate being a portion of an actuator device;
forming a layer of PZT material overlying the isolation layer; and
patterning the layer of PZT material.

2. The method of claim 1 wherein the forming of the layer is provided by a deposition process maintained less than 300 Degrees Celsius.

3. The method of claim 1 wherein the isolation layer is polyimide.

4. The method of claim 1 wherein the patterned PZT layer forms a portion of an actuation device.

5. The method of claim 4 wherein the portion is selected from an entire portion of the actuation device, a tongue portion of a gimbal, a tongue portion of a gimbal and a fixed gimbal portion.

6. The method of claim 1 further comprising forming a plurality of conductive traces overlying a second surface of the substrate.

7. The method of claim 1 further comprising patterning the substrate to form a tongue portion of a gimbal structure.

8. The method of claim 7 further comprising bonding a slider device on the tongue portion of the gimbal structure.

9. The method of claim 7 wherein the patterning comprises forming a photoresist layer overlying the second surface of the substrate.

10. The method of claim 1 wherein the patterned PZT structure includes a pair of actuation devices, each of the actuation devices being operably coupled to a slider device.

11. An integrated gimbal and PZT structure, the device comprising:
a substrate, the substrate including a first surface and a second surface, the first surface being opposite to the second surface and sandwiching a thickness of material of the substrate;
an isolation layer formed overlying the first surface of the substrate;
a patterned layer of PZT material overlying the isolation layer overlying the substrate;
a tongue portion formed from a first portion of the substrate for a gimbal structure of a suspension assembly; and
a spring portion formed from a second portion of the substrate, the spring portion being coupled between a lower portion of the suspension assembly and the tongue portion.

12. The device of claim 11 wherein the suspension assembly is coupled to a voice motor coil.

13. The device of claim 11 wherein the patterned layer of PZT material is provided by a photolithography process.

14. The device of claim 11 further comprising a plurality of conductive members coupled to the second surface.

15. The device of claim 11 wherein the patterned PZT material includes a pair of PZT structures, each of the PZT structures being operably coupled to a slider device.

16. The device of claim 11 further comprising a first electrode overlying a first side of the patterned PZT material and a second electrode overlying a second side of the patterned PZT material.

17. The device of claim 11 further comprising an insulating layer overlying the second side of the substrate.

18. A method for fabricating an integrated gimbal and PZT structure, the method comprising:
forming a first isolation layer overlying a first surface of a substrate, the substrate being a portion of a gimbal structure;
forming a second isolation layer overlying a second surface of the substrate;
forming a first electrode layer overlying the first isolation layer;
forming a layer of PZT material overlying the first isolation layer using a deposition process maintained at less than 300 Degrees Celsius,;
forming a second electrode layer overlying the PZT material;
patterning the layer of PZT material, the first electrode, and the second electrode;
patterning the substrate to define the portion of the gimbal structure.

19. The method of claim 18 wherein the portion of the gimbal structure is a tongue portion of a gimbal structure.

20. The method of claim 19 wherein the gimbal structure is for a suspension assembly.
